(19) United States
(12) Patent Application Publication
(10) Pub. No.: US 2011/0272395 A1
(43) Pub. Date: Nov. 10, 2011

(54) Method for Joining Tubes, Rods and Bolts

(76) Inventor: Per Thomas Moe, Drammen (NO)

(21) Appl. No.: 12/741,986

(22) PCT Filed: Nov. 10, 2008
(86) PCT No.: PCT/NO2008/000399

§ 371 Date: May 13, 2011

(30) Foreign Application Priority Data
Nov. 9, 2007 (NO) 20075787

(51) Int. Cl. H05B 11/00; H05B 3/02; H05B 6/02

(52) U.S. Cl. 219/601; 219/148; 219/67; 219/56

(57) ABSTRACT

The present invention concerns a method for forge welding of tubes, rods, bolts or other axial symmetrical profiles. According to the methods the profile ends are formed by plastic deformation and/or machine cutting processes, such that they obtain a reduced cross section/thickness, the profile ends are locally heated electromagnetically by induction and/or direct high frequency resistance heating and profile ends are then pressed together. The forming step comprises given one of the profile ends a double arched shape. Preferably the other profile end is given a convex shape.

### FIELD OF THE INVENTION

The invention concerns a method for welding tubes, bolts and rods, or other profiles with an essentially circular or similar cross section consisting of one, two or more layers of material.

### TECHNICAL BACKGROUND

For many applications it is natural to use tubes, rods, bolts and other elements of relatively simple geometry consisting of one or several layered materials. In a number of cases the materials in such profiles may fulfill different functions. An internal core of copper may be surrounded by one or several layers of steel tubes with very different properties. The copper conducts electricity or heat, while the steel tube protects the copper and provides mechanical strength. A possible alternative to such a design will, in some cases, be an internal core of steel and an external lube of copper.

Another possible use of different materials in constructions is insulating tubes, where internal and external metallic tubes are separated by a material which insulates electrically and thermally. In some relations it can also be economically beneficial to use several metals in the same profile. As tubes for the oil industry, relatively inexpensive CMn-tubes are likely to be used. By coating such tubes with an internal layer of stainless metallic material, the external tube will be protected against corrosion. An external protective stainless steel tube is also a theoretical possibility. High pressure water pipes can also advantageously be prepared with an internal and external stainless coating.

In conventional welding it is very difficult to ensure good fusion of all layers in profiles consisting of several metals. Metals melt at different temperatures, and it is generally very difficult or time-consuming to join metals which are inside a bolt or between two layers of metals. It is often not desirable to mix materials, since this may give a weld with unwanted mechanical properties and defects. Conventional welding is also time-consuming compared with methods of both pressure welding and friction welding. In the case of automatic methods for welding, such as friction and flash welding, it is very difficult to ensure a uniform layer thickness and good mechanical properties for the product.

Forge welding is a relevant method for joining of tubes, rods and bolts. A forge welding process may consist of three distinct phases:
1. Profile ends are sharpened/beveled so that the cross sectional area is reduced up to 60%. The beveling can be carried out by plastic deformation and/or by machining processes. The operation can either be carried out as a part of the welding operation, or as a completely separate process at the steel mill.
2. The profile ends are heated locally to a surface temperature between 900-1300° C. The gradient in the axial direction may for example be 1000° C./cm. This heating can either be carried out by induction or by direct application of a high frequency electrical current.
3. During heating, a reducing gas consisting of for example H2, may be used to remove oxides and prevent new corrosion of the end surfaces of the profiles.
4. The profiles are quickly pressed towards each other, at the same time as welding by diffusion and local plastic deformation occurs. During the deformation, a high pressure is ensured as the profile ends are shaped with a cross section with reduced thickness. During the forging stage the cross sectional area of the weld gradually increases until it is equal or larger than the size of the profiles. No melting occurs.

Traditionally, there has been insufficient focus on the establishment of contact and the subsequent contact mechanics and plastic deformation relating to pressure welding methods. However, it is of large significance for the quality of the weld that the bevel is closed and forged correctly. Particularly in relation to forge welding of multilayer tubes or bolts, it is important to ensure good contact in all parts of the profile in order to ensure satisfactory joining in all layers. As mentioned above, the layer that melts most easily can be smeared out and disturb the joining of the other layers. The challenges related to forge welding of multilayer materials are:
1. The materials may have different melting temperatures.
2. The materials may have different thermo-mechanical properties.
3. The materials may have different electromagnetic properties.
4. The material layers may be thin and loosely attached.

### SUMMARY OF THE INVENTION

An object of the present invention is to provide both an optimal and robust method for enhanced diffusion or forge welding of tubes, rods and bolts. Furthermore, an object is also to provide a method by diffusion and forge welding of multilayer tubes, rods and bolts, where satisfactory joining is achieved in all layers.

By shaping the profile ends in a particular way it is possible to solve these challenges; this is achieved by the method which is described in the appended patent claim. More precisely, the invention comprises a method for joining tubes, rods, bolts and other axial symmetric profiles end-to-end, comprising shaping the profile ends by plastic deformation and/or machining processes such that they obtain a reduced cross section/thickness, local heating of the profile ends electromagnetically by induction and/or direct high frequency resistance heating, hot forging of the profile ends, one of the profiles' end surfaces being shaped such that its cross section consists of a double-arched curve, where the profile ends have varying distance in the radial direction, and where the tube profile ends initially meet with a blunt angle between the fitting surfaces.

### BRIEF DESCRIPTION OF THE DRAWINGS

The invention is illustrated in the appended drawings, in which

FIG. 1a depicts a cross section of a tube with a classical bevel shape for use in forge welding,

FIG. 1b depicts a so called double-arched bevel shape, a bevel shape consisting of both a convex and a concave part,

FIG. 2 depicts details of the double-arched shape of FIG. 1b,

FIG. 3 depicts the principle of forge welding with convex and double-arched profile ends,

FIG. 4 describes errors which may occur in forge welding,

FIG. 5 describes a method for finding an optimal shape of the profile end for forge welding,

FIG. 6 describes a profile with 3 layers,

FIG. 7 is an example of simple pre-forming the profile end by plastic shaping by expansion with subsequent turning,

FIG. 8a shows an example of pre-forming the profile by plastic forming by upsetting and in subsequent turning, while FIG. 8b shows a bevel for a bi-metallic tube made by plastic deformation and turning,

FIG. 9 shows an example of a design of part profile ends for bolt and rod, consisting of two layers with metals (here called bi-metallic bolts and rods),

FIG. 10 shows a tube with an internal layer consisting of a different material from the external layer,

FIG. 11 is an example of design of part profile ends for tubes with two layers,

FIG. 12 shows an example of welding of tubes with part profile ends,

FIG. 13 shows an example of bi-metallic rods or bolts, which consist of a steel core coated with copper (a) and a copper core coated with steel, respectively.

### DETAILED DESCRIPTION

The invention will now be described in detail with reference to the drawings mentioned above.

The invention is a method for joining or welding tubes, bolts, rods and other profiles consisting of one, two or several materials, but where at least one of the layers is metallic. The profiles are preferably elongated and axially symmetric or similar, and the ends which are to be joined have similar shape. The materials of the profiles can be found in distinct layers which extend in the axial direction, and have the same distribution in each of the two parts. The material properties of the layers may differ significantly. A tube consisting of several layers of metals is referred to as multi metallic.

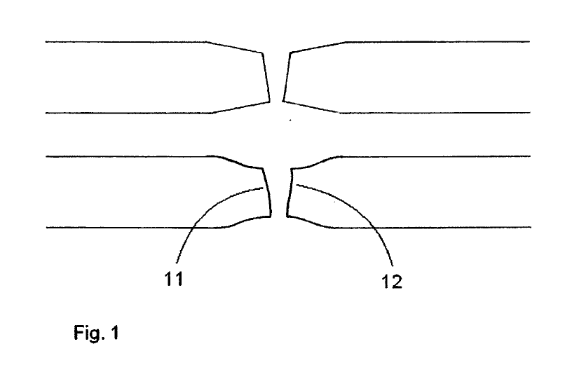

The invention is based on a new development for all types of forge or pressure welding, including forge welding of only one material type, in that contact between the profiles is gradually established from one side of the profile to the other side, preferably in the direction opposite to the flow of reducing gas. For tubes, this usually corresponds to closing from the outside to the inside of the profile. While one of the end surfaces has a purely convex shape, the other may consist of both a convex and concave shape, here designated as double-arched shape. The end surface may be inclined at different angles relative to the direction of the profile axes, but it is always prepared in a way that ensures gradual closing from one side to the other side. The purpose of the described design is to ensure an optimal and robust mechanism for closing of the gap separating the pipe ends. For example, the design allows parts to be joined to be significantly displaced and angled relative to each other. During the closing the contact will be gradually established over the thickness, while a pressure wave and a zone with local plastic deformation is moving along the welding. This provides a kind of zipper mechanism, with good and well defined pressure and deformation conditions during welding. The double-arched shape of one of the end surfaces ensures that the ends do not meet in a sharp angle at the same time as the bevel surfaces are properly closed at the inner side of the profiles. The shape of the bevel can simply be adjusted in order to ensure best possible conditions during both welding and resistance or induction heating. It is pointed out that in the text, seam surface and the end surface are used as synonymous terms for the surface shown as 11 or 12 in FIG. 1.

As mentioned, one of the end surfaces may have a purely convex shape. It can also have other shapes, such as conical or double-arched shapes. The double-arched shape may be symmetrical, corresponding to the double-arched shape of the other end surface. Such embodiments of the profiles ensure that the end surfaces to begin with meet (in a fitting surface) along one of the edges of the profiles, for example along the external edge, in a blunt angle which may approach 0°, and that there is a gradually larger distance between the end surfaces in the radial direction of the profiles as seen in a cross section. Also the shoulders/side surfaces of the profiles may have a double-arched shape, consisting of two circle segments and possibly a straight part.

FIG. 1 and FIG. 1b show two tube walls which are joined by forge welding. FIG. 1 shows one half of a section through a tube profile. The ends of the profiles have been beveled, and there is a gap between the inclined end surfaces. The shape is simple to make, and during forging the contact pressure will be concentrated in the area where the profiles are to meet first. A gradual closing of the gap will occur with a continuous supply of reducing gas. However, this shape has some disadvantages. The first contact between the bevel surfaces occurs at the point where the plane normals of the bevel surfaces are not parallel. This is the causes of uncertainty with respect to the initial establishment of contact and the final shape of the weld. A cap is likely to be formed with an uneven surface at the outside of the finished weld, i.e. it is not possible to make the surface of the weld as smooth as desirable. In particular, if the parts to be joined are not perfectly aligned, the result may become particularly unsatisfactory.

A more robust solution is obtained by using bevel surfaces which are defined by pure convex lines in the cross section. The normals of the surface in the first touching point should then be almost parallel with the forge direction in heated condition. With a pure convex design of both bevel surfaces, there will, however, be a risk that the gap between the bevels is incompletely closed. The reason is that the surfaces near the end of the seam or fusion line meet at an angle and that, in many cases, and in particular in connection to welding of bi-metallics, it may be very difficult to enforce plastic deformation that ensures proper closing. An indent will in that case be formed. Another problem with purely concave bevel surfaces is that the distance between profiles must vary significantly across the gap between the bevels. To ensure even heating, the differences in the width of the gap over the thickness should be small. With small variations in the gap distance it will, however, be difficult to ensure gradual closing of the gap in the correct direction at the same time as the local plastic deformation at the surface becomes small.

The profiles shown in FIG. 1b have a more favorable design, i.e. according to the present invention. One of the end surfaces 11 is given a purely convex design, while the opposite surface 12 at the other profile has been given a double-arched design, i.e. a convex shape changing to a concave shape. This provides a more favourable angle between the profile ends when they meet. Further, the arcs of these surfaces are formed in such a way that they follow each other carefully and variably without risk for incomplete closure at the inner edge of the weld line. This allows more accurate control during heating of the ends of the profiles and a more accurate closing mechanism.

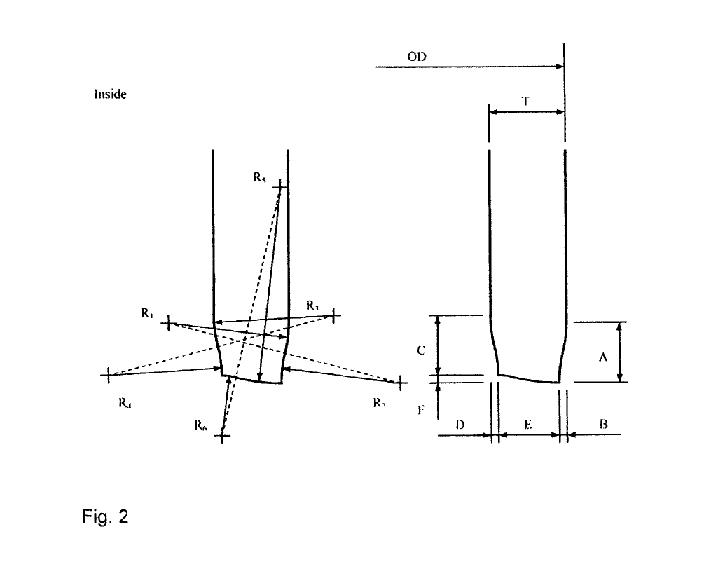

FIG. 2 shows the contours in a cross section of a profile bevel with double-arched shapes. The part is rotationally symmetrical, and has an outer diameter, OD, and a thickness, T. The bevel surface is of the simplest type of double-arched shape. Each curve in the plane is described by only two circle segments. In order to reduce the number of independent parameters in the model and to ensure optimal contact conditions, the curves are made without sudden changes in the tilting.

The geometry may then be described by a total of nine independent parameters, for example A, B, D, E, F, ra=(R2/R1), rb=(R4/R3) and rc=(R6/R5). If E and F are known, then the sum of the radius Rc=R5+R6 may be determined by the expression:

$${R}_{c} = \frac{F}{( 1 - cos θ )} where cos θ = \frac{{E}^{2} - {F}^{2}}{{E}^{2} + {F}^{2}}$$

R5 and R6 can then be determined if rc is known. If R6 and rc are close to 0, the curve to of the bevel surface will be purely concave. If R5 is close to 0 and rc is approaching infinity, the curve that defines the bevel surface will be purely convex. The Cartesian coordinates at any point on the bevel surface can be determined by trigonometric relations, if a suitable origo is selected. Hence, the curves can be described in simple manner, in both the 2- and 3-dimensional space.

A correction of the bevel shape must be made in order to compensate for thermal expansion of the material. The effect of the thermal expansion is that the bevel surface rotates slightly. The bevel surfaces must be shaped so that the normal to the planes in the first contact point, after heating and possibly skew clamping of the profiles, are parallel, or in total have a radial component in a direction which is parallel to the direction for closing of the welding.

The described shape is only an example of a double-arched shape. It is fully possible to describe double-arched shapes in alternative ways, either by using circle segments or polynomial functions. The advantage of the described double-arched shape is that there are very few parameters; only one parameter in addition to the two parameters for a straight line. All double-arched shapes that allow extensive adjustment and optimization of the shape of the bevel may advantageously be used for forge welding purposes, and are covered by the claims in the text.

It is no condition that the side surfaces of the profile ends are described by double-arched shapes. Simple line segments can be used, as well as complex polynomial functions. The advantage of the double-arched shape is that the surface of the weld has no sharp edges and uneven sections. Again, a double-arched shape described by two circle segments will represent the absolutely simplest description.

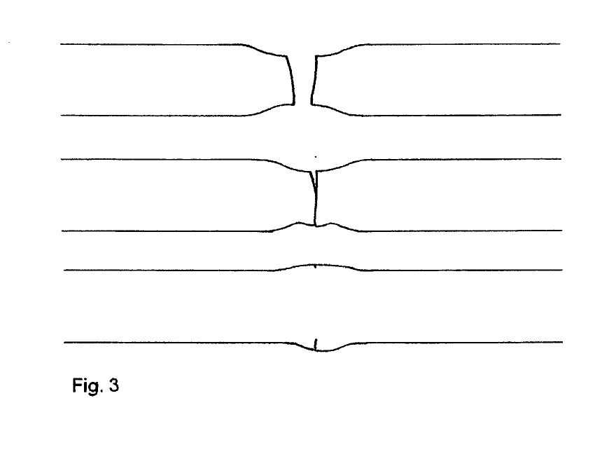

FIG. 3 shows different stages during forging by forge welding with the double-arched shape. The bevel surfaces get into contact and the weld is gradually established before a cap is formed at both the outer side and the inner side of the tube. The final shape of the weld depends on the original shape of the bevel, the temperature distribution in the parts, material parameters and process conditions, such as forging velocity and forging in length, as well as convection conditions.

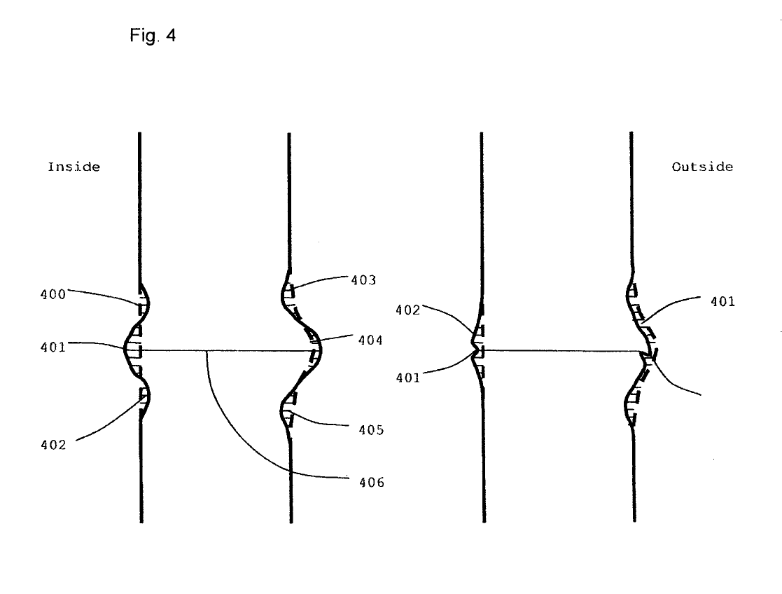

FIG. 4 shows welds that deviate from the target shapes. The target shapes of the weld are described by the dashed lines. The real or actual shape is described by the full lines. The area/volume of positive and negative deviations should ideally be 0, but the shape of the welds can deviate significantly from the target shape.

The figure on the left hand side shows a weld with reduced wall thickness. Such deviations will reduce the mechanical integrity of the weld and are not desirable. At the inside of the weld it may be desirable, for various reasons, that there be no cap. Also in this aspect the shape of the weld is not optimal.

At the right hand side, another weld is shown with a somewhat reduced thickness and with the cap at the inside. The deformation has taken place somewhat more in the inward direction than desirable. Furthermore, at the inside of the weld, the gap has been incompletely closed. The thermo-mechanical conditions have, during forging, not been adequate to close the inside of the welding. This may result in crack initiation and growth and stress corrosion during use. At the outer side of the weld, an undesirable folding has taken place. Both these effects can be observed when bevels not being double-arched are used.

It is emphasized that both the previous and the subsequent figures show the appearance of the profile ends in the hot condition. Because of the heating of the end surfaces and the thermal expansion, they will usually rotate somewhat relatively to each other. This must be taken into account during forming of the profile ends in the cold condition. The shape of the profile ends are here called convex, concave and double-arched. However, the double-arched embodiment also includes as border cases pure convex, concave and plane shapes. The precise shape should be tuned to the physical properties of the materials, the temperature picture and the desired final shape of the weld. A best shape can be found by solving a classical Optimization problem. The simplest shape of a double-arched bevel is one consisting of two circle segments. The circle segments may have different radii, and should preferably meet in a smooth transition. Where extra precision is required, the surfaces may be described by mathematical splines or similar.

During heating as well as upsetting, a reducing gas is used to remove oxides and prevent new corrosions of the profile ends. It has previously been shown that pure hydrogen or chlorine gas can be used, but it is now also shown that the gas can consist of a mixture of nitrogen and hydrogen; the composition depending on the material properties. The advantage of using a mixture of hydrogen (typically 5 to 20%) and nitrogen is that the gas is non-explosive. At high temperatures it is found that the nitrogen gas also contributes to removal of oxides on the surface of the steel at high temperatures.

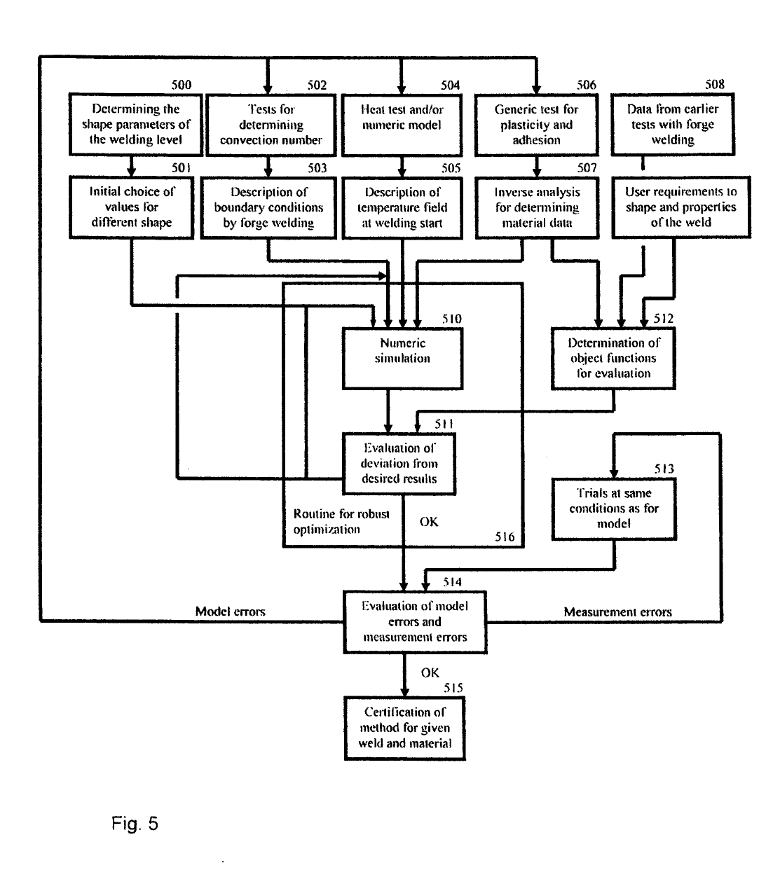

FIG. 5 shows a method for determination of optimum bevel shape. In this relation an optimum bevel shape is a shape e that gives the best results for all conceivable conditions and for possible process deviations during welding. Thus, the method does not only focus on optimizing with respect to certain objective requirements but also on generating a process that is as robust as possible. With result it is in this connection meant the shape and properties of the weld.

The method makes use of numerical tools, such as finite element methods for rapid optimization of shape. In connection with the use of numerical modelling tools, it is of great significance that there is a large degree of certainty related to process conditions and material behaviour. For this reason, material testing is done in order to determine heat conduction properties and describing elastic and plastic behaviour of the material. The original distribution of temperature in the part can either be determined experimentally or by a satisfactory numerical model. It can also be determined by inverse analyses. In that case the temperature distribution should be described by a small number of parameters. Pressure, deformation and temperature conditions that secure a good weld are found through the planned experiments and, with the aim of contact mechanics, micromodels for adhesion are established.

Requirements for shape and properties of the weld are determined by the users. Requirements are given in standards. The object functions express the deviation between simulated results and requirements. The weighting of requirements is carried out in a rational manner, depending on how the weld is to be used and the requirements of the user. If, for a given bevel shape, one is not able to establish a weld with satisfactory quality, then the values of the bevel shape parameters are changed before new simulations are undertaken. The procedure is followed until a shape is found which is both optimal and robust. A number of different methods of optimization exist, which can be used in this connection. If, for a specific material, a certain temperature distribution and under certain process conditions, it is not possible to satisfy the user requirements, it may be possible to adjust process conditions and the original temperature distribution until a satisfactory result is achieved. It is of great significance that, during evaluation of the robustness of the method, one considers deviations which by nature are of a three dimensional character. This implies that an analysis of consequences misalignment, tilting and offset should be made.

When a satisfactory result has been obtained, it must be validated through systematic experiments. By conducting a large number of measurements it is possible to find out whether possible deviations between experiment and model are due to measurement errors or modelling errors. In the case that the deviation is due to modelling errors, the model has to be further examined and it may be necessary to carry out specific experiments that reveal the cause of possible errors. If deviations are due to measurement errors, measurement equipment must be calibrated. When a satisfactory agreement between the model and the experiment exists, the weld can be certified for relevant combinations of bevel, material and process conditions. All results are stored in a database which is gradually expanded as new experimental data are established.

The basis of the method is a clear definition of the customer requirements regarding the weld shape and properties, 509. Requirements are usually expressed in standards but, if desirable, particular requirements can be put forward by the customer.

The target shape of the weld shall normally be described by two functions f(z) and g(z). The variable z is here the distance from the fusion/seam line in the direction of the axes. The function f(z) is the difference between the radial coordinate for a point at a distance z at the outer surface of the part and the outer diameter of the part, OD. The function g(z) similarly is the difference between the inner diameter of the part, ID, and the radial coordinate for a point at a distance z from the fusion line at the internal surface of the part. Hence, the following situations may arise:

f(z)>0, g(z)>0: the thickness of the weld in position z shall be larger than the thickness of the part
f(z)<0, g(z)<0: the thickness of the weld in position z shall be less than the thickness of the part.

It is quite possible to demand that f(z)=g(z)=0 for all z, which means that the geometry of the weld shall be equal to the geometry of the part. Functions of the following type are normally used:

f(z)=A exp(−Bz²)

Here, A is the maximum deviation from the OD, of the part, while B states how rapid the shape deviation tends towards 0 in the axial direction. A similar function may be applied for g(z). Normally a requirement is that the value of A is less than 10% of the wall thickness. It is of course fully possible to put A=0.

The customer may also prescribe requirements for the mechanical and metallurgical properties of the weld. These requirements can not be used directly in an analysis. The properties of the weld depend on the thermo-mechanical treatment of the base material and of die contact conditions during welding. In order to relate the properties to the parameters from the analyses experience data 508 are used, as well as models for contact and adhesion, 508, 509. The models are established by dedicated small scale experiments and inverse modelling. This means that the shape and the parameters of the models are determined by a routine which minimizes the deviation between the model and the measurement. In any case the models link temperature, pressure, deformation and time to the quality of the weld. The simplest type of such a model is a special value which states whether sufficient pressure, sufficient temperature or sufficient degree of deformation that must be achieved to ensure satisfactory welding. It is also possible to demand that combinations of the given parameters shall satisfy specific requirements. Model data are material dependent, and must be established for each individual case.

Central to the method for analysis is the use of numerical tools for evaluation of the weld shape and properties, 510. The finite element method (FEM) permits analysis of complex forming operations for complex material behaviour and geometry. The part which is formed and welded is subdivided into a number of small elements. For the simplest formulations, in each corner of the element there will be a node which is exposed to forces causing deformations in agreement with a described behaviour of material. The relationship between forces and displacement for a group of nodes belonging to one or several elements may be expressed by a set of algebraic equations.

Usually the forming problems are non-linear. This requires use of an iterative routine for determination of offset changes as a result of a change in the load. In the case boundary conditions, such as contact between tools and a part, are known, the non-linear equations can for example be solved with a Newton-Rapson technique. The result is a description of displacements and internal forces in the part over time during forging.

Forge welding occurs at a high temperature and temperature gradient, and during a gradual change of the temperature. The finite element model includes calculations of temperature changes during forging, and there is a two-way connection between the mechanical and the thermal calculations. Plastic deformation generates heat and contributes to heating, while the behaviour of the materials is affected by the temperature. The basic equation for the mechanical calculations is Newton's 2nd law, while the basic equation for the thermal problem is the equation for conservation of energy. Additionally constitutive relations describing the behavior of the material are required.

Forge welding of rotational symmetrical parts, such as tubes, may ideally be modelled as a problem in two dimensions. With this is meant that only radial and axial displacements are allowed. Forces may act in the tangential direction, but this is of less significance in solving the system of the equations. Simplification to only two dimensions makes it possible to carry out a large number of calculations and experimenting on a number of combinations of geometry parameters during a short time period. Thus, such calculations are perfectly suited ter optimization studies. Three dimensional analyses are necessary in order to evaluate possible deviations from axi-symmetric conditions, for example due to shape or process deviations. Such deviations may be due to relative tilting or offset of the parts.

The finite element method is foremost a mathematical tool. All information about material behaviour and process conditions must be described prior to the calculations. Establishment of the material data and data about boundary conditions occur through experience and analyses. Plastic flow data at different temperatures are established by ring upsetting in isotherm conditions, 506. Adhesion experiments are conducted under controlled conditions with small samples and almost isothermal conditions. Data from both types of experiments are compared with results from models describing different phenomena.

In connection with the solution of the heat conduction problem, it is important to determine the heat convection coefficient as well as the emissivity. At the surface of the part both natural and forced convection may take place. The heat transfer coefficient is determined through representative experiments with very good control of temperature and circulation, 502. The radiation is normally determined by optical means, and in order to determine heat transfer coefficient and emissivity, analytical and numerical models for the experimental set up are used. The models are then implemented in the analyses of forge welding, 503. Also for other boundary conditions such as, for example, friction, submodels are established prior to the analyses of the welding.

The temperature distribution prior to forging greatly affects the outcome of the process. The temperature has a first order effect on both the final geometry of the weld and on the pressure and deformation during forging. The temperature also influences the metallurgy. The distribution of temperature for forge welding is determined by the heating method, normally high frequency resistance heating or induction heating. The temperature profile may to a large extent be adjusted and optimized. Usually the temperature distribution can be approximately described by the function T(z):

T(z)=(T_{MAX}−T₀)exp(−KZ)+T₀

where T_{MAX} is the maximum temperature during forging, T₀ is preheating temperature and the K is a parameter which determines the extension of the temperature field. The temperature distribution and the shape of the pipe end should be adapted to each other by optimization, but there are some limits to such adaptation. The determination of the original temperature distribution is done by heating experiments or by numerical simulation tools, 504. By solving Maxwell's equations for high frequency current, as well as the equation for conservation of energy, it is possible to estimate temperature distribution. Such a calculation will of course demand precise determination of material parameters such as the permeability, resistivity, the heat transfer coefficient and the specific heat capacity. The analysis makes possible optimal adaptation of the temperature distribution to the subsequent deformation conditions. At the first iteration of an optimization study for forge welding, however, a temperature distribution based on data from previous welding experiments with similar materials and process conditions, 505 is used.

It is of great significance for the optimization study that the geometry of the bevel is described precisely with as few parameters as possible, 500. FIG. 2 shows an example of a so-called double-arched bevel with double-arched sides. In total, the geometry can be described by nine completely independent geometry parameters, for example A, B, D, E, F, rₐ=(R₂/R₁), r_{b}=(R₄/R₃) and r_{c}=(R₆/R₅). If the thickness 10 is given, there are only eight independent parameters since the sum of B, D and F are equal to T. Other bevel shapes can also be used, but no bevel shape will offer a similarly satisfactory relation between bevel functionality and complexity. It is possible to use double-arched shapes in combination with purely convex shapes, but in that case the degree of symmetry in the analyses is reduced and the number of independent parameters is increased. It is of course possible to use other combinations of parameters for the given bevel in the optimization study. If T is thickness of the part, it will be appropriate to use non-dimensional parameters, such as A/T, C/T, B/C, D/C and E/T and F/E in connection with the analyses.

For the different shape parameters a set of reasonable values for the shape parameters in 501 should initially be selected. This selection is based on experience. Also, a type of analysis is developed which enables very rapid determination of natural selection of the ratios A/B and C/D. In this analysis, first a part whose shape is initially described by the functions Fᵢ(z)==0 and Gᵢ(z)==0 is studied. The part is subject to tensile forces simultaneously with application of a temperature distribution as described above. When subject to tensile forces, the reduction of the part's cross-section begins immediately with plastic deformation in the warm zone. The ratios A/B and C/D are continuously monitored. In order to give best possible imitation of the conditions during forging, the development of heat transfer and ductility are inverted. It is worth noting that the method is not intended to be an exact inverse analysis, but rather a starting point for the real inverse analysis. To ensure that the start analysis provides reasonable results, validation calculations with a traditional forward analysis are undertaken.

Prior to a numerical analysis, the customer requirements must be converted to objective criteria for use in evaluation of the results from the analyses 512. A basic requirement is that the final shape of the weld shall be in agreement with the target shape. The functions F_{c}(z) and G_{c}(z) describe the external and the internal shape of the weld after the forging. The functions f(z) and g(z) described above describe the target form after forging. The deviation between target and actual shape can for example be described by the difference:

$$D = {\int }_{0}^{∞} ( \frac{{( {G}_{c} ( z ) - g ( z ) )}^{2}}{{g ( z )}^{2}} + \frac{{( {F}_{c} ( z ) - f ( z ) )}^{2}}{{f ( z )}^{2}} ) d z$$

It is also possible to more strongly emphasize on the negative deviations, if thickness reductions are not desirable. Other shape deviations, such as systematic displacement of the bevel against the inside or the outside, can also be quantified.

The deviation D can be calculated for continuous functions from z=0 to infinity. In numerical calculations, discrete values for the shape deviation are used. The deviations are calculated in each node on the surface of the part in the element model. Node position deviations are summed up and weighted.

In connection with the accurate analysis of the results from numerical calculations and deviations between the calculated and the target shape 511, it is important to know that, in connection with plastic deformation, it may be assumed that the mass is conserved and the material is incompressible. If thermal expansion and elastic compression are neglected, it can then be assumed that the part volume in the first time step will be just as large as the volume in the last. If the forge length is not determined a priori by the user, the forging length will be adapted to the analyses, such that the final shape of the welding is in best possible agreement with the target shape. This must be the case after unloading and cooling. If a material between two analyses is heated further, the forge length will be adjusted according to the thermal expansion and change in forge pressure. The method takes account of thermal and mechanical conditions in the early simulation steps. The effect of pressure and temperature is estimated with use of the thermal elastic equations.

Shape constitutes the primary optimization criterion. It is also possible to include, in the object function itself, deviations between target pressure and calculated pressure, and target and calculated deformation at the contact surfaces. Other relevant parameters can also be included. A better solution is however to include requirements for pressure, strain and temperature as implicit and explicit constraints in connection with the optimization of shape. Solutions which do not satisfy the minimum requirements for so pressure, damnation and temperature cannot be considered as optimum.

Another optimization requirement is that the solution is robust. By this one means that the probability of experiencing a welds which do not satisfy requirements for shape or properties due to result of natural process variations, shall be very small and satisfy the customer requirements. Variability in the process shall be much smaller than the tolerances which are set (ref Six Sigma approach). Different methods are implemented for robust optimization. For robust optimization it must be assumed that a stochastic distribution is associated with the object function. There is both an expected value μ_{D} and standard deviation σ_{D} for the deviation D. During robust optimization, a so-called metamodel is established for μ_{D} and σ_{D}, with basis in a larger set of simulations. This is a surface in several dimensions in the parameter space, a response surface (ref. R. H. Myers and D. C. Montgomery: Response Surface Methodology, Wiley, 2002). A minimum is sought for the response surface for μ_{D}. It is also possible to search for minimum standard deviation for different parameter combination, or a minimum of a weighted sum of the expected value and the standard deviation. However, it is more common to demand that the sum of the expected value for D, and three times the standard deviation for D, is not larger than a given threshold value. This ensures that the in selected bevel produces results better than required usually at sufficient level of safety. If there are any explicit or implicit restrictions on parameters, one should also consider natural deviations which may occur for the parameters in the model, for example associated with the original bevel shape or temperature distribution. The result of the robust optimization may be a movement of the optimum away from the limits defined by constraints, and to flat parts of the response surface. A similar method is described in M. H. A. Bonte, A. H. van den Bogaard and R. van Ravenswaaij, Robust Optimization of metal forming processes, Proceedings of the 10^{th} ESAFORM Conference, Zaragoza, Spain, pp. 9-14. When using response surfaces or similar, the interpolation must be controlled afterwards.

Different optimization techniques are used for determination of optima, in the purely deterministic as well as the stochastic case. A number of methods can be used to search for local optima on smooth surfaces (distributions of D). Reference is made to general literature related to optimization theory.

The innermost feedback arrow, 501 between 510 and 511 indicates that searches are undertaken until the optimum has been found. This may take place whereby evaluations of the object functions can be made between each simulation. As stated, above it is often more appropriate and efficient to establish a meta-model, a response surface, through simulation, and then search for minimum, validate the result and thereafter carry out calculations iteratively in order to obtain a better estimate. Both methods can be used in the algorithm.

The outermost feedback arrow, 502′ between 510 and 511, indicates that a search for a set of initial and boundary conditions are terminated if, after a certain number of searches, it is not possible to obtain a satisfactory result, i.e. a weld which has the target shape and properties. In this case, the initial and if possible, the boundary conditions must be changed. In that case, the cap of the weld is not sufficiently extended in the longitudinal direction; the routine will modify the distribution of the temperature field such that more plastic deformation takes place at a distance from the weld. At the same time a message is given, regarding the old temperature distribution, that there is no bevel which could give a satisfactory shape on the weld. The user of the routine is also given the opportunity to change the target shape of the weld, or to modify the requirements for shape and properties.

When a weld with satisfactory shape has been established, a comparison is made, 514 of results from numeric modelling with results of experiments, 513, where parts with the suggested optimal shape are joined. During the welding, sensors continuously record temperatures, displacements, forces and shape. Then, the properties of the welds are checked (hardness, yield limit, fracture resistivity, ductility and fatigue resistivity) by destructive testing and metallurgical analyses. If there are significant deviations between numerical and experimental results, it will be evaluated whether these are due to errors in modelling or measurement. Inconsistent measurements indicate that there are one or several measurement errors. If the measurement results are consistent, but there is a deviation between model and measurement, the initial and boundary condition of the model are checked. In particular it can be necessary to change the temperature distribution, so that it is in better agreement with the experimental data.

When model and experiment are in good agreement, the method can be certified for a given combination of material and bevel shape. For this purpose there are standards for conventional welding methods. To the extent that the requirements in these standards are relevant, they are also used for forge welding. However, the systematic method described above ensures a weld with satisfactory properties, which can be used in spite of very significant variations in the input parameters. All experiences which are gained through simulation and forging are stored in a database for later use in connection with qualification of the method for other materials and welding parameters. The relationship between result and parameters is stored in a regression formula or in an artificial neural network (ANN).

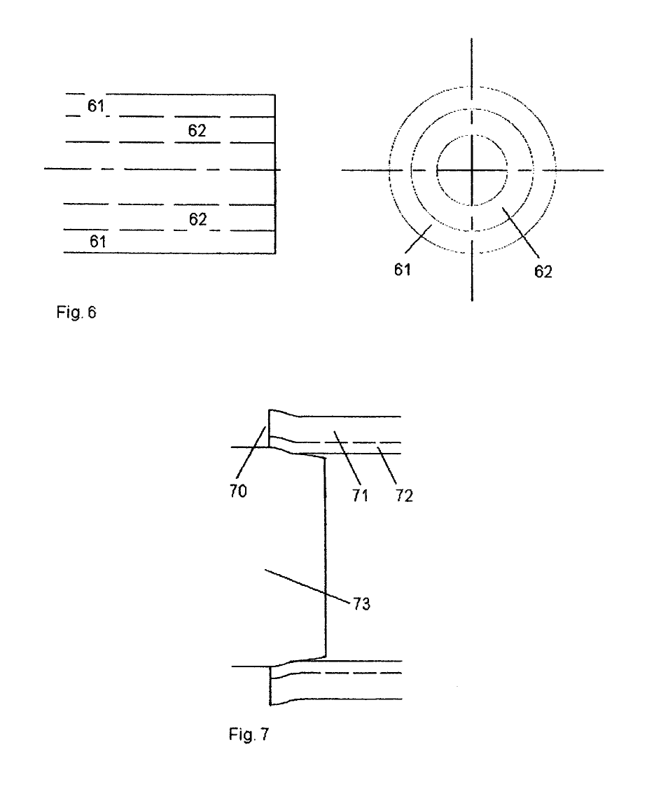

For profiles consisting of several material layers, as illustrated in FIG. 6, the same basic principles as for welding of profiles which only consist of one layer will apply. Here, the layers 61 and 62 are of different metals. The surfaces of the profile ends should preferably be convex and double-arched, both globally (for whole thickness) and locally (for the layer). It is also important to reduce the cross section of the profile ends prior to the forging. This ensures a triaxial stress conditions in the contact and a high contact pressure during the deformation, at the same time as the final cross section of the welding can be equal to the cross section of the profile.

When welding tubes with several layers, the innermost layer is often very thin. In this case, the inside of the tube cannot be machined without the inner layer being completely removed by machining or significantly reduced in thickness. It has previously been suggested that the thickness of the inner layer should be maintained while material is removed only from the outside of the profile. This is an unsatisfactory solution, and in particular for the case where the internal layer comes in contact first. First of all, it will in be difficult to maintain contact pressure and, for that reason, no satisfactory weld is established in the outer layer. Instead, a large internal cap is formed with a large kerf in the internal layer. Hence it is of great significance that the bevel is more or less centrally situated in the tube wall and that closure occurs as prescribed from the outside to the inside and generally in the direction against the flow of the reducing gas in a gradual is manner.

The following two methods are suggested in welding of tubes consisting of several materials:

Prior to the turning of the tube end 70, the tube may be expanded plastically with a conical tool 73. The degree of the expansion depends on tube dimensions, but the tube should be expanded more than the thickness of the inner layer 72, FIG. 7. The tube 70 will in that case assume a funnel shape. Then a conical end shape can be machined and the cross section of the end of the tube is reduced with up to 60%, but most usually to only 65% of the original thickness. An alternative to expansion is to upset the end of the tube with an internal and, if required, an external tool 83 until the thickness of the coating 82 constitutes more than about 20% of the original wall thickness, FIG. 8. Then the tube end is cut to the desired shape. Another alternative consists of the tube ends being rolled to the desired shape. The tube end is made so that contact first takes place at the external circumference in order to propagate inwards. The gas is introduced from the inside. The internal coating 82, will then finally be welded. If the internal coating is harder than rest of the tube, because of a lower temperature or other material properties, it is possible to heat this part of the tube locally by induction or similar methods prior to and during the forging. The equipment for the expansion and upsetting can be integrated in the tool kit, consisting of a hydraulic press and a metal cutting tool, which is applied in the terminating phase of the manufacturing. During expansion, upsetting and rolling, the material may be heated by for example induction in order to reduce required force needed to deform the material and to reduce spring-back.

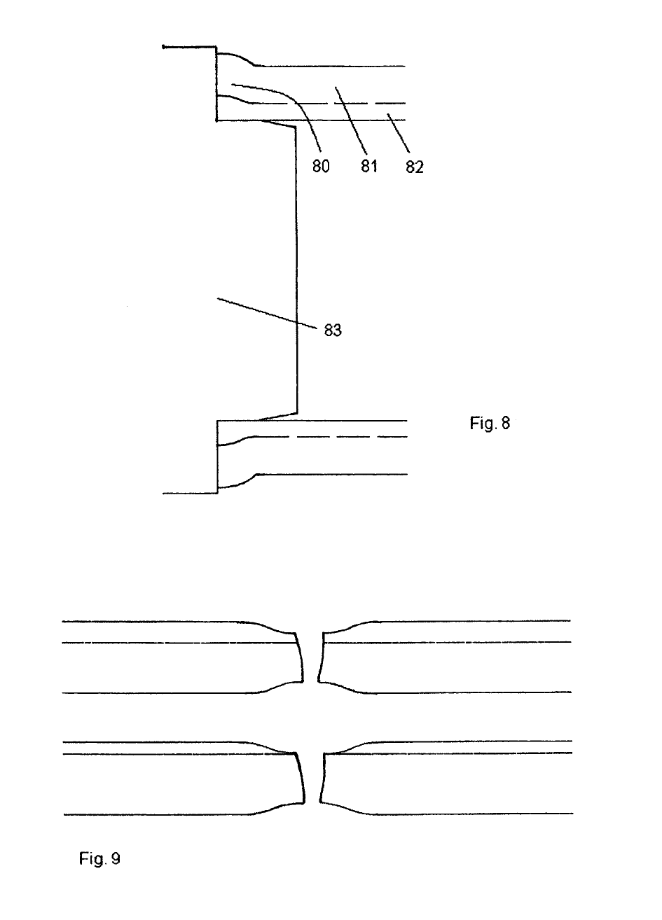

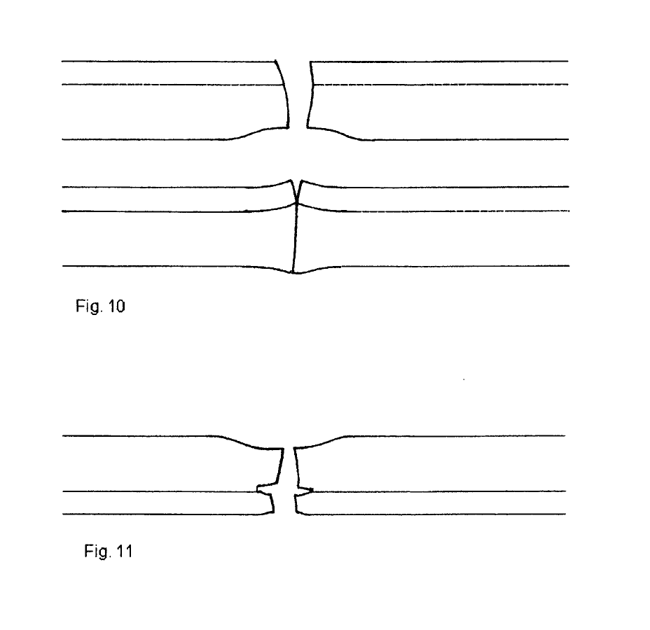

The welding progress itself, in the above method, is illustrated in FIGS. 9 and 10. FIG. 9 shows the profile ends when they are ready machined. In the profiles shown at the top, the external coating is thicker than for the bottom profiles. FIG. 10 shows an example where the profiles are guided towards each other and the gap between the profile ends is closed.

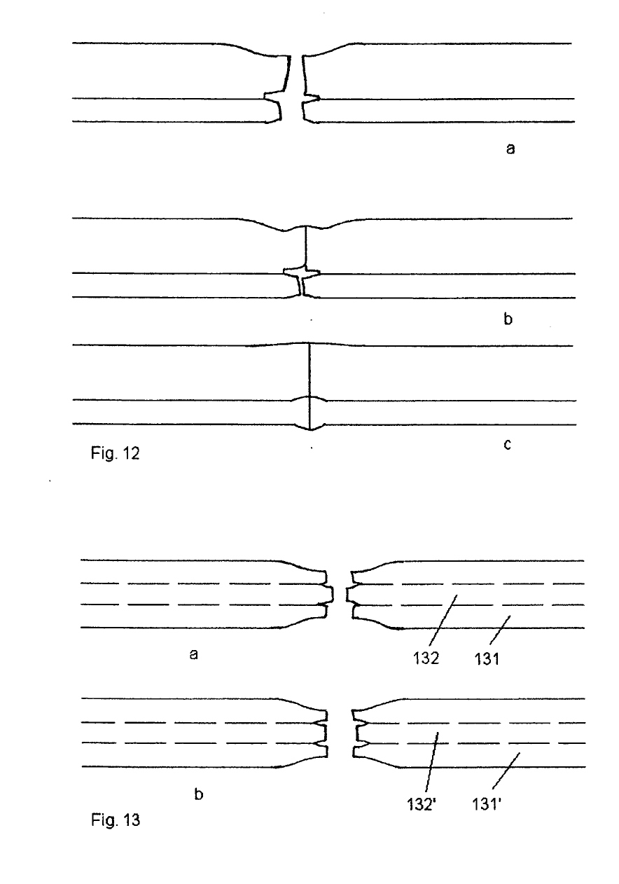

The other method consists of shaping both the internal layer and the rest of the tube, such that they almost behave independently of each other during plastic deformation. In in this case, a groove is made between the internal coating and the rest of the tube, FIG. 11, 12a. The depth of the groove should be larger than the width of the layer in order to ensure satisfactory plastic deformation. By beveling the profile end, a satisfactory triaxial stress condition and a high contact pressure in the internal layer is obtained, as well as in the rest of the profile end during forging. In this case it will also be advantageous to establish contact at the external edge of the tube first, and then propagate inwards until the gap finally is closed with the internal layer, FIG. 12b. This presumes that the reducing gas is introduced from the internal side of the tube. After the tube has been welded, the groove between the base material and the internal layer is closed by upsetting, FIG. 12c. If the tube or the bolt consist of several layers, it will in principle be, possible to make part profile ends for each individual layer.

In the case of forge welding of bolt and rod consisting of an internal core and an external layer, FIG. 13, profile ends for each layer and for the core may also be formed. In that case, profiles with a copper core 132′, surrounded by one or several layers of steel 131′, shall be joined, the external layer of steel 131′ shall first be forged together before the copper 132′ is brought in contact, FIG. 13b. The end of the steel is made in the same way as the end of a tube, and the forging process itself is in principle carried out in the same way as for a tube. The copper is drawn down in a distance from 0.1 to 30 mm, depending on the profile dimensions. Contact in the copper core is established at the end of the forging sequence. A metallic bonding is also obtained between the copper core, which has a lower temperature than the steel and also a lower melting temperature. After contact has been established, the material is forged a further distance, so that it tills the groove between the steel and the copper.

In the case where the steel constitutes the internal core 132, and is surrounded by copper 131, the ideal geometry will depend on the heating process. However, it will in all cases be advantageous to shape bevels for steel and copper separately. If the copper melts or gets a significantly higher diffusivity, the copper may pollute the steel bevel and prevent satisfactory bonding between the steel parts. By using part profile ends, as described above, it is possible to avoid this type of treatment, FIG. 13a.

For the described methods for joining multilayer tube bolts, far better results are usually obtained when each part layer in the ends of the tubes/bolts/profiles is given convex and double-arched shapes, respectively, as explained previously. However, it is also possible to join such profiles when every part layer is given a classical plane forming.

1. Method for joining tubes, rods, bolts and other axial symmetrical profiles end to end, comprising:
a. forming of the profile ends by plastic deformation and/or metal cutting processes, such that they obtain a reduced cross section/thickness;
b. local heating of the profile ends, electromagnetically by induction and/or by direct high frequency resistance heating;
c. pressing of the profile ends together;
wherein one of the end surfaces of the profiles are shaped such that it in the cross section view is represented by a double arched-curve, where the distance between the profile ends varies in the radial direction, and where the two profile ends initially meet with a blunt angle between the mating surfaces.

2. Method according to claim 1, comprising giving the end surface of the second profile a convex, conical or double-arched shape.

3. Method according to claim 2, wherein the end surfaces are shaped such that the plane normals in the first contact point, after heating and possible a skew clamping of the profiles, are parallel, or in sum have a radial component in a direction parallel to the direction for closing of the weld gap.

4. Method according to claim 1, comprising also providing a double-arched shape to the shoulders/side surfaces of the profile ends.

5. Method according to claim 1, comprising introducing a reducing gas during the heating and pressing of the profile ends to remove oxide layers from the surfaces of the bevels and to prevent new oxidation.

6. Method according to claim 5, where as reducing gas is applied pure H₂ or a non-explosive gas mixture of H₂ and N₂.

7. Method according to claim 5, where the gap between the profile ends first is closed on the opposite side of where the gas is being introduced, and then subsequently is closed on the side where the gas is being introduced.

8. Method according to claim 1, where the profiles consist of two or several metallic layers with distinct thermo-mechanical and electromagnetic properties and metallurgy.

9. Method according to claim 1, where the profiles consists of two or several layers with distinct thermo-mechanical and electromagnetic properties and physics, where at least one of the layers is metallic.

10. Method according to claim 7, where there are rotational symmetric or elliptical grooves or recesses in the axial direction between the layers are formed.

11. Method according to claim 7, where the profile ends are shaped such there are distinct level differences between the layers of the profiles, such that the layers during pressing/forging gets into contact at different points of time, and are being deformed to different degrees.

12. Method according to claim 7, where the profile ends are shaped such that the thickness of one or several of the layers are locally reduced with up to 60% near the profile ends to a depth corresponding to 5 times the thickness of the layer or the profile.

13. Method according to claim 11, where the thickness of the innermost layer constitutes more than about 25% of the tube thickness, and the thickness of the internal layer is reduced with up to 80% during the shaping of the profile end.

14. Method according to claim 11, where thickness of the innermost layer constitutes less than about 25% of the thickness of the profile.

15. Method according to claim 7, where the end of the tube is plastically expended before a metal cutting tool makes a profile end with reduced cross section.

16. Method according to claim 7, where the end of the tube is made thicker through upsetting before a machine cutting tool forms a profile end with reduced cross section.

17. Method according to claim 7, where an internal coil is used to locally induction heat the interior of the tube, locally, directly prior to and during upsetting in addition to heating with an external coil or direct resistance heating.

18. Method according to claim 1, where oxide material on the external side of the profile and possible internal side, is machined to a distance of 50 mm or more in order to avoid oxides from reaching the bevel.

19. Method according to claim 7, where the profiles are a bolt or a rod, and where the internal layer consists of copper and the external layer consists of steel.

20. Method according to claim 7, where the profile is a bolt or a rod and where the internal layer consists of steel and the external layer consists of copper.

21. Method according to claim 7, where the profile is a tube, and where the internal layer consists of a corrosion resistant alloy and the external layer consists of a more inexpensive alloy.

22. Method according to claim 1, where the side surfaces of the profile ends are shaped as double-arched lines in the cross section.

23. Method according to claim 1, where optimum shape of the profile ends is determined for different materials and temperature distributions by numerical calculations and/or planned experiments, as well as a method for optimization, where one establishes requirements for target weld shape and forging conditions, defines a minimum number of geometrical parameters, and defines an objective function, giving the deviation between the target and calculated/measured actual shape and minimizes this deviation while possible other limitations in the forming are taken into account.
